(19) United States
(12) Patent Application Publication
(10) Pub. No.: US 2023/0100671 A1
(43) Pub. Date: Mar. 30, 2023

(54) ELECTRICAL CONNECTOR SYSTEM

(71) Applicant: TE Connectivity Solutions GmbH, Schaffhausen (CH)

(72) Inventors: Christopher George Daily, Harrisburg, PA (US); Matthew Edward Mostoller, Hummelstown, PA (US); James Paul Scholz, Mechanicsburg, PA (US)

(21) Appl. No.: 17/953,955

(22) Filed: Sep. 27, 2022

Related U.S. Application Data
(60) Provisional application No. 63/249,098, filed on Sep. 28, 2021.

(51) Int. Cl. H01R 12/71; H01R 13/26

(52) U.S. Cl. CPC H01R 12/716; H01R 13/26; H01R 13/6581

(57) ABSTRACT

An electrical connector system includes a receptacle connector assembly and a header connector assembly mated with the receptacle connector assembly. The receptacle connector assembly includes a receptacle connector housing holding receptacle contacts in a plurality of rows. The header connector includes a header connector housing holding header contacts in a plurality of rows. The contacts are laterally offset and longitudinally staggered in the rows to provide spacing between the contacts.

### CROSS REFERENCE TO RELATED APPLICATIONS

This application claims benefit to U.S. Provisional Application No. 63/249,098, filed 28 Sep. 2021, titled “ELECTRICAL CONNECTOR SYSTEM”, the subject matter of which is herein incorporated by reference in its entirety.

### BACKGROUND OF THE INVENTION

The subject matter herein relates generally to electrical connector systems.

Electrical connectors are used to electrically connect components within a system. For example, the electrical connectors may be mounted to circuit boards to electrically connect the circuit boards. The electrical connectors have mating ends that are mated together in a mating direction. The mating ends are intended to be oriented parallel to each other in the mating direction. If mated at an angle, the contacts or other components may be damaged. Additionally, when mated at an angle, the contacts may short-circuit if mated at to the incorrect, adjacent contact, particularly when the contacts are arranged on a tight pitch.

A need remains for an electrical connector system having high contact density.

### BRIEF DESCRIPTION OF THE INVENTION

In one embodiment, an electrical connector system is provided and includes a receptacle connector assembly including a receptacle connector housing holding receptacle contacts in a plurality of rows. The receptacle connector housing has a mounting end and a mating end opposite the mounting end. The mounting end is configured to be mounted to a circuit board. The receptacle connector housing has a front wall extending longitudinally between a first end and a second end of the receptacle connector housing. The receptacle connector housing has a rear wall extending longitudinally between the first end and the second end. The receptacle connector housing has a central wall positioned laterally between the front wall and the rear wall and extending parallel to the front wall and the rear wall. The receptacle connector housing has a front receptacle between the front wall and the central wall. The receptacle connector housing has a rear receptacle between the rear wall and the central wall. The front and rear receptacles are open at the first and second ends of the receptacle connector housing. The receptacle contacts includes front receptacle contacts, rear receptacle contacts, front central receptacle contacts and rear central receptacle contacts. The front receptacle contacts extend along the front wall and are exposed at the front receptacle. The rear receptacle contacts extend along the rear wall and are exposed at the rear receptacle. The front central receptacle contacts extend along a front side of the central wall and are exposed at the front receptacle. The rear central receptacle contacts extend along a rear side of the central wall and are exposed at the rear receptacle, wherein the front receptacle contacts and the front central receptacle contacts are laterally offset on opposite sides of the front receptacle and longitudinally staggered relative to each other on opposite sides of the front receptacle, and wherein the rear receptacle contacts and the rear central receptacle contacts are laterally offset on opposite sides of the rear receptacle and longitudinally staggered relative to each other on opposite sides of the rear receptacle. The electrical connector system includes a header connector configured to be mated with the receptacle connector. The header connector includes a header connector housing holding header contacts in a plurality of rows. The header connector housing has a mounting end and a mating end opposite the mounting end. The mounting end is configured to be mounted to a circuit board. The mating end of the header connector housing is mated to the mating end of the receptacle connector housing. The header connector housing has a front outer wall extending longitudinally between a first end and a second end of the header connector housing. The header connector housing has a rear outer wall extending longitudinally between the first end and the second end. The header connector housing has a front inner wall positioned laterally between the front wall and the rear wall closer to the front outer wall than the rear outer wall. The header connector housing has a rear inner wall positioned laterally between the front wall and the rear wall closer to the rear outer wall than the front outer wall. The header connector housing has a front slot between the front outer wall and the front inner wall. The header connector housing has a rear slot between the rear outer wall and the rear inner wall. The header connector housing has a central slot between the front inner wall and the rear inner wall. The front slot receives the front wall of the receptacle connector housing. The rear slot receives the rear wall of the receptacle connector housing. The central slot receives the central wall of the receptacle connector housing. The header contacts include front header contacts, rear header contacts, front central header contacts and rear central header contacts. The front header contacts extend along a front side of the front inner wall and exposed at the front slot. The rear header contacts extend along a rear side of the rear inner wall and exposed at the rear slot. The front central header contacts extend along a rear side of the front inner wall and exposed at the central header. The rear central header contacts extend along a front side of the rear inner wall and are exposed at the central slot, wherein the front header contacts and the front central header contacts are longitudinally staggered relative to each other on opposite sides of the front inner wall, and wherein the rear header contacts and the rear central header contacts are longitudinally staggered relative to each other on opposite sides of the rear inner wall. The front wall of the receptacle connector housing is received in the front slot of the header connector housing. The rear wall of the receptacle connector housing is received in the rear slot of the header connector housing, and the central wall of the receptacle connector housing is received in the central slot of the header connector housing. The front receptacle contacts are electrically connected with corresponding front header contacts. The rear receptacle contacts are electrically connected with corresponding rear header contacts. The front central receptacle contacts are electrically connected with corresponding front central header contacts. The rear central receptacle contacts are electrically connected with corresponding rear central header contacts.

In another embodiment, a receptacle connector assembly is provided and includes a receptacle connector housing has a mounting end and a mating end opposite the mounting end. The mounting end is configured to be mounted to a circuit board. The mating end of the receptacle connector housing is configured to be mated to a header connector housing the receptacle connector housing having a front wall that extends longitudinally between a first end and a second end of the receptacle connector housing. The receptacle connector housing has a rear wall extending longitudinally between the first end and the second end. The receptacle connector housing has a central wall positioned laterally between the front wall and the rear wall and extending parallel to the front wall and the rear wall. The receptacle connector assembly includes a front receptacle between the front wall and the central wall. The front receptacle is open at the first and second ends of the receptacle connector housing. The receptacle connector assembly includes a rear receptacle between the rear wall and the central wall. The rear receptacle is open at the first and second ends of the receptacle connector housing. The receptacle connector assembly includes front receptacle contacts extending along the front wall and exposed at the front receptacle. The receptacle connector assembly includes rear receptacle contacts extending along the rear wall and exposed at the rear receptacle. The receptacle connector assembly includes front central receptacle contacts extending along a front side of the central wall and exposed at the front receptacle. The receptacle connector assembly includes rear central receptacle contacts extending along a rear side of the central wall and exposed at the rear receptacle. The front receptacle contacts and the front central receptacle contacts are laterally offset on opposite sides of the front receptacle and longitudinally staggered relative to each other on opposite sides of the front receptacle. The rear receptacle contacts and the rear central receptacle contacts are laterally offset on opposite sides of the rear receptacle and longitudinally staggered relative to each other on opposite sides of the rear receptacle.

In a further embodiment, a header connector assembly is provided and includes a header connector housing having a mounting end and a mating end opposite the mounting end. The mounting end is configured to be mounted to a circuit board. The mating end of the header connector housing is configured to be mated to a receptacle connector housing. The header connector housing has a front outer wall extending longitudinally between a first end and a second end of the header connector housing. The header connector housing has a rear outer wall extending longitudinally between the first end and the second end. The header connector housing has a front inner wall positioned laterally between the front wall and the rear wall closer to the front outer wall than the rear outer wall. The header connector housing has a rear inner wall positioned laterally between the front wall and the rear wall closer to the rear outer wall than the front outer wall. The header connector assembly includes a front slot between the front outer wall and the front inner wall. The front slot is configured to receive a front wall of the receptacle connector housing. The header connector assembly includes a rear slot between the rear outer wall and the rear inner wall. The rear slot is configured to receive a rear wall of the receptacle connector housing. The header connector assembly includes a central slot between the front inner wall and the rear inner wall. The central slot is configured to receive a central wall of the receptacle connector housing. The header connector assembly includes front header contacts extending along a front side of the front inner wall and exposed at the front slot. The header connector assembly includes rear header contacts extending along a rear side of the rear inner wall and exposed at the rear slot. The header connector assembly includes front central header contacts extending along a rear side of the front inner wall and exposed at the central header. The header connector assembly includes rear central header contacts extending along a front side of the rear inner wall and exposed at the central slot. The front header contacts and the front central header contacts are longitudinally staggered relative to each other on opposite sides of the front inner wall. The rear header contacts and the rear central header contacts are longitudinally staggered relative to each other on opposite sides of the rear inner wall.

### BRIEF DESCRIPTION OF THE DRAWINGS

FIG. 1 illustrates an electrical connector system in accordance with an exemplary embodiment showing a receptacle connector assembly and a header connector assembly.

FIG. 2 illustrates the electrical connector system in accordance with an exemplary embodiment.

FIG. 3 is a top perspective view of the receptacle connector assembly in accordance with an exemplary embodiment.

FIG. 4 is an exploded view of the receptacle connector assembly in accordance with an exemplary embodiment

FIG. 5 is a top view of the receptacle connector assembly in accordance with an exemplary embodiment.

FIG. 6 is a bottom perspective view of the receptacle connector assembly in accordance with an exemplary embodiment.

FIG. 7 is a cross-sectional view of the receptacle connector assembly in accordance with an exemplary embodiment taken through one of the front receptacle contacts and one of the rear central receptacle contacts.

FIG. 8 is a cross-sectional view of the receptacle connector assembly in accordance with an exemplary embodiment taken through one of the rear receptacle contacts and one of the front central receptacle contacts.

FIG. 9 is a top perspective view of the header connector assembly in accordance with an exemplary embodiment.

FIG. 10 is an exploded view of the header connector assembly in accordance with an exemplary embodiment.

FIG. 11 is a top view of the header connector assembly in accordance with an exemplary embodiment.

FIG. 12 is a bottom perspective view of the header connector assembly in accordance with an exemplary embodiment

FIG. 13 is a horizontal cross sectional view of a portion of the header connector assembly in accordance with an exemplary embodiment.

FIG. 14 is a vertical cross sectional view of a portion of the header connector assembly in accordance with an exemplary embodiment.

FIG. 15 is a vertical cross-sectional view of the electrical connector system showing the receptacle connector assembly mated with the header connector assembly with an exemplary embodiment.

FIG. 16 is a horizontal cross-sectional view of the electrical connector system showing the receptacle connector assembly mated with the header connector assembly with an exemplary embodiment.

FIG. 17 is an enlarged view of a portion of the electrical connector system shown in FIG. 16. with an exemplary embodiment.

FIG. 18 is a cross-sectional view of the electrical connector system showing the header connector assembly partially mated with the receptacle connector assembly with an exemplary embodiment.

### DETAILED DESCRIPTION OF THE INVENTION

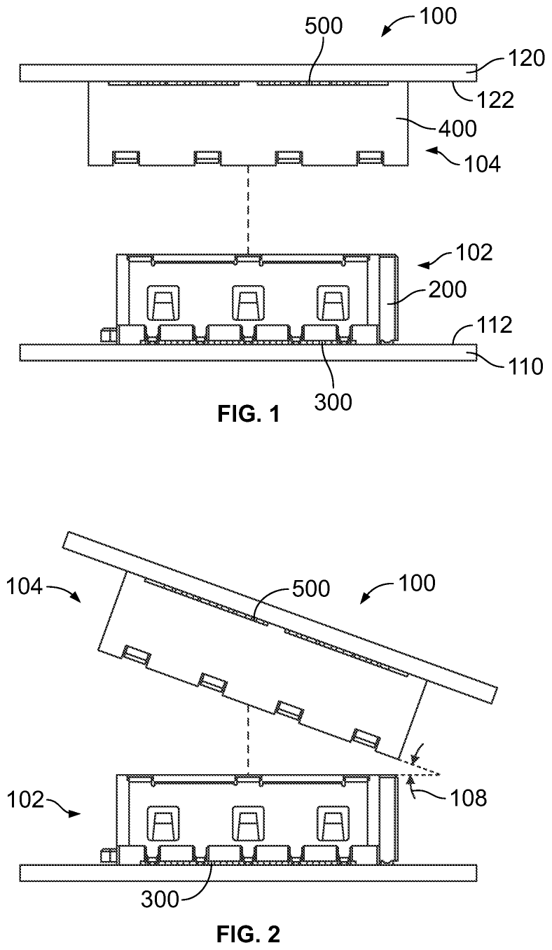

FIG. 1 illustrates an electrical connector system 100 in accordance with an exemplary embodiment showing a receptacle connector assembly 102 and a header connector assembly 104. The receptacle connector assembly 102 and the header connector assembly 104 are configured to be mated along a mating axis 106. In the illustrated embodiment, the receptacle connector assembly 102 is a circuit board assembly and the header connector assembly 104 is a circuit board assembly. However, in alternative embodiments, the receptacle connector assembly 102 and/or the header connector assembly 104 may be a cable connector assembly having a connector provided at ends of one or more cables.

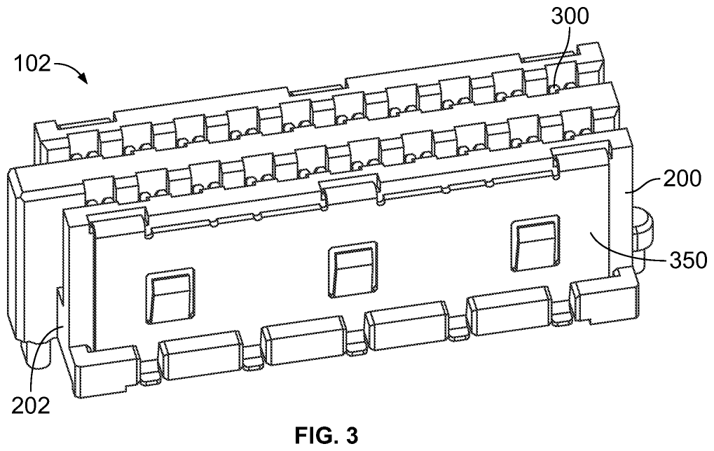

The receptacle connector assembly 102 includes a receptacle connector housing 200 holding a plurality of receptacle contacts 300 (shown in FIG. 3) and a receptacle circuit board 110. The receptacle connector housing 200 is coupled to a surface 112 of the receptacle circuit board 110, such as an upper surface. The receptacle contacts 300 are electrically connected to the receptacle circuit board 110. For example, the receptacle contacts 300 may be soldered to the receptacle circuit board 110 or may be press-fit into plated vias or may be spring biased against pads at the surface 112. The receptacle circuit board 110 includes conductors, such as traces, pads, vias, and the like for me various circuits of the receptacle circuit board 110 electrically connected to corresponding receptacle contacts 300. The conductors are provided at one or more layers of the receptacle circuit board 110. The receptacle circuit board 110 may include one or more ground layers.

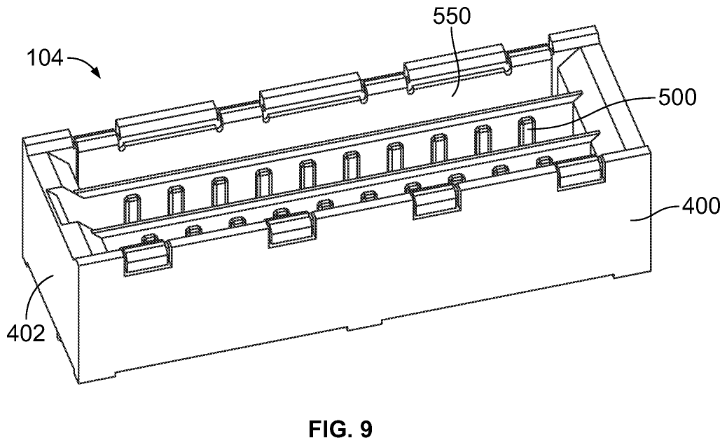

The header connector assembly 102 includes a header connector housing 400 holding a plurality of header contacts 500 (shown in FIG. 9) and a header circuit board 120. The header connector housing 400 is coupled to a surface 122 of the header circuit board 120, such as an upper surface. The header contacts 500 are electrically connected to the header circuit board 120. For example, the header contacts 500 may be soldered to the header circuit board 120 or may be press-fit into plated vias or may be spring biased against pads at the surface 122. The header circuit board 120 includes conductors, such as traces, pads, vias, and the like for me various circuits of the header circuit board 120 electrically connected to corresponding header contacts 500. The conductors are provided at one or more layers of the header circuit board 120. The header circuit board 120 may include one or more ground layers.

In an exemplary embodiment, the header connector assembly 104 is configured to be mated with the receptacle connector assembly 102 such that the header circuit board 120 and the receptacle circuit board 110 are oriented parallel to each other. The receptacle connector and the header connector form interposer connectors between the parallel circuit boards 110, 120. In alternative embodiments, the receptacle connector or the header connector may be a right angle connector such that the receptacle circuit board 110 and the header circuit board 120 may be oriented perpendicular to each other. While it may be intended that the receptacle connector assembly 102 and the header connector assembly 104 are mated such that the mating ends are parallel to each other (and perpendicular to the mating axis 106), the connector assemblies 102, 104 may be configured to accommodate mating at a skewed angle (with the mating ends nonparallel to each other).

FIG. 2 illustrates the electrical connector system 100 in accordance with an exemplary embodiment. In the illustrated embodiment, the header connector assembly 104 is oriented at a skewed angle 108 such that the mating end of the header connector assembly 104 is nonparallel to the mating end of the receptacle connector assembly 102. In an exemplary embodiment, the connector assemblies 102, 104 accommodate mating at the skewed angle by providing open slots for the contacts 300, 500 and with the contacts 300, 500 spaced apart to avoid short-circuiting during mating.

FIG. 3 is a top perspective view of the receptacle connector assembly 102 in accordance with an exemplary embodiment. The receptacle connector housing 200 holds a plurality of the receptacle contacts 300 in a plurality of rows. In an exemplary embodiment, the receptacle connector assembly 104 includes one or more receptacle shields 350 that provide electrical shielding for the receptacle contacts 300. In the illustrated embodiment, the receptacle shields 350 are provided at the front and rear ends of the receptacle connector assembly 102 to shield the receptacle contacts 300 from interference with components outside of the receptacle connector assembly 102.

The receptacle connector housing 200 includes a housing body 202. The housing body 202 is manufactured from a dielectric material, such as a plastic material. For example, the housing body 202 may be a molded part. In an exemplary embodiment, the housing body 202 is a single piece structure. However, in alternative embodiments, the housing body 202 may be a multi-piece structure. The housing body 202 is used to hold the receptacle contacts 300 and the receptacle shields 350. The dielectric material of the housing body 202 isolates the receptacle contacts 300 from each other and from the receptacle shields 350.

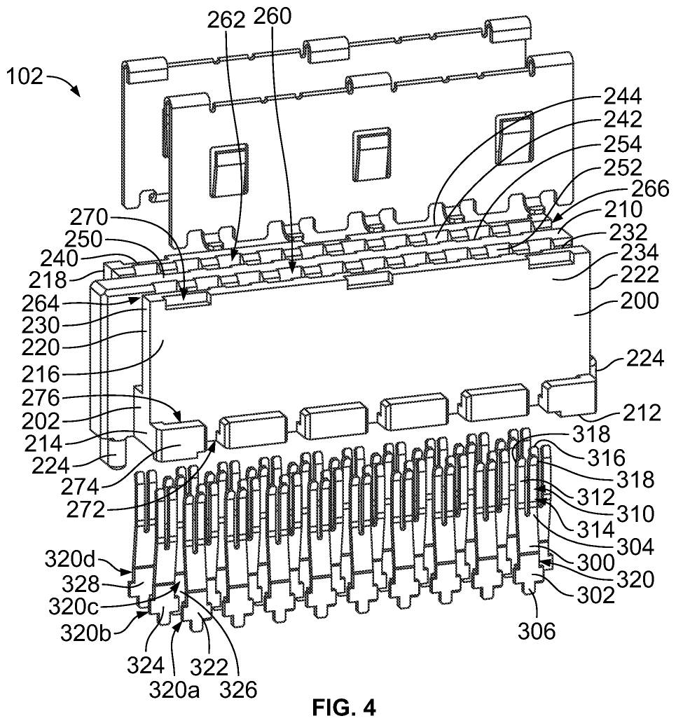

FIG. 4 is an exploded view of the receptacle connector assembly 102 in accordance with an exemplary embodiment. FIG. 4 shows the receptacle contacts 300 below the receptacle connector housing 200. FIG. 4 shows the receptacle shields 350 above the receptacle connector housing 200. The receptacle contacts 300 may be loaded into the receptacle connector housing 200 from below and the receptacle shields 350 may be coupled to the receptacle connector housing 200 from above. The receptacle connector assembly 102 may be assembled in other ways in alternative embodiments.

The receptacle connector housing 200 extends between a mating end 210 and a mounting end 212. The mating end 210 is configured to be mated with the header connector assembly 104 (shown in FIG. 1). In the illustrated embodiment, the mating end 210 is provided at the top and the mounting end 212 is provided at the bottom. Other orientations are possible in alternative embodiments. In an exemplary embodiment, the receptacle connector housing 200 includes a base 214 at the mounting end 212. The base 214 is configured to be mounted to the receptacle circuit board 110 (shown in FIG. 1). In an exemplary embodiment, the base 214 extends the entire width and the entire length of the receptacle connector housing 200.

The receptacle connector housing 200 includes a front 216 and a rear 218. Optionally, the front 216 and/or the rear 218 may be generally planar and parallel to each other. Optionally, the receptacle connector housing 200 may include pockets, slots, openings, protrusions, tabs, or other features at the front 216 and/or at the rear 218, such as to accommodate the receptacle shields 350.

The receptacle connector housing 200 includes a first end 220 and a second end 222 opposite the first end 220. In an exemplary embodiment, the receptacle connector housing 200 includes mounting tabs 224 at the first end 220 and/or the second end 222 for mounting the receptacle connector housing 200 to the receptacle circuit board 110. For example, the mounting tabs 224 may extend from the mounting end 212. The mounting tabs 224 may include posts or other protrusions configured to extend into openings in the receptacle circuit board 110. In alternative embodiments, the mounting tabs 224 may include openings, such as to receive fasteners or other securing features for securing the receptacle connector housing 200 to the receptacle circuit board 110.

The receptacle connector housing 200 includes a front wall 230 extending longitudinally between the first end 220 and the second end 222 of the receptacle connector housing 200. The front wall 230 includes an inner side 232 and an outer side 234. The outer side 234 faces an exterior of the receptacle connector housing 200. In an exemplary embodiment, the receptacle shield 350 is configured to be coupled to the outer side 234 of the front wall 230. A plurality of the receptacle contacts 300 are arranged along the front wall 230 in a row.

The receptacle connector housing 200 includes a rear wall 240 extending longitudinally between the first end 220 and the second end 222 of the receptacle connector housing 200. The rear wall 240 includes an inner side 242 and an outer side 244. The outer side 244 faces an exterior of the receptacle connector housing 200. In an exemplary embodiment, the receptacle shield 350 is configured to be coupled to the outer side 244 of the rear wall 240. A plurality of the receptacle contacts 300 are arranged along the rear wall 240 in a row.

In an exemplary embodiment, the receptacle connector housing 200 includes a central wall 250 extending longitudinally between the first end 220 and the second end 222 of the receptacle connector housing 200. The central wall 250 includes a front side 252 and a rear side 254. The central wall 250 is positioned laterally between the front wall 230 and the rear wall 240. The central wall 250 may be centered between the front wall 230 and the rear wall 240. The central wall 250 extends parallel to the front wall 230 and the rear wall 240. A plurality of the receptacle contacts 300 are arranged along both sides 252, 254 of the central wall 250 in corresponding rows.

A front receptacle 260 is located between the front wall 230 and central wall 250. The front side 252 of the central wall 250 faces the front receptacle 260. The inner side 232 of the front wall 230 faces the front receptacle 260. A rear receptacle 262 is located between the rear wall 240 and the central wall 250. The rear side 254 of the central wall 250 faces the rear receptacle 262. The inner surface 242 of the rear wall 240 faces the rear receptacle 262. In an exemplary embodiment, the front receptacle 260 includes openings 264 at the ends 220, 222 and the rear receptacle 262 includes openings 266 at the ends 220, 222. The openings 264, 266 receive portions of the header connector assembly 104 such that the header connector assembly 104 is able to pass entirely through the receptacles 260, 262 and extend from the ends 220, 222. The receptacles 260, 262 form open chambers that are open to each of the corresponding receptacle contacts 300 that face the receptacles 260, 262.

In an exemplary embodiment, each of the receptacle contacts 300 are identical. However, in alternative embodiments, the receptacle contacts 300 may be sized and shaped differently and/or include different features from each other. In an exemplary embodiment, the receptacle contacts 300 are stamped and formed contacts. Each receptacle contacts 300 includes a main body 302, a mating end 304 extending from the main body 302 and a terminating end 306 extending from the main body 302. In the illustrated embodiment, the mating end 304 is provided at the top of the receptacle contact 300 and the terminating end 306 is provided at the bottom of the receptacle contact 300. Other orientations are possible in alternative embodiments. In the illustrated embodiment, the receptacle contacts 300 extend generally vertically; however, the receptacle contacts 300 may have other shapes or orientations in alternative embodiments.

In the illustrated embodiment, the terminating end 306 is illustrated as a solder tab. However, other types of terminating ends may be provided in alternative embodiments, such as compliant pins (for example, eye of the needle pins), spring beams, solder tails, or other types of terminating ends.

In an exemplary embodiment, the mating end 304 includes a deflectable spring beam 310. The spring beam 310 is cantilevered from the main body 302 and is deflectable when mating with the header connector assembly 104. The spring beam 310 may have a generally curved shape such that the spring beam 310 is non-coplanar with the main body 302. For example, the spring beam 310 may be curved to extend into the receptacles 260, 262 to interface with the header connector assembly 104. In an exemplary embodiment, the spring beam 310 may be bifurcated to provide multiple points of contact with the header connector assembly 104. For example, the spring beam 310 may be split to include a first spring arm 312 and a second spring arm 314 extending parallel to each other and separated by a gap 316. Each of the spring arms 312, 314 include a corresponding mating interface 318 at or near the distal end of the spring arm 312, 314. Other types of spring beams may be used in alternative embodiments. In other various embodiments, other types of mating ends may be provided, such as blades, pins, sockets, and the like.

In an exemplary embodiment, the receptacle contacts 300 are arranged in a plurality of rows 320. For example, a first row 320a of the receptacle contacts 300 may be provided at the front wall 230, a second row 320b of the receptacle contacts 300 may be provided at the front side 252 of the central wall 250, a third row 320c of the receptacle contacts 300 may be provided at the rear side 254 of the central wall 250, and a fourth row 320d of the receptacle contacts 300 may be provided at the rear wall 240. The receptacle contacts 300 in the first row 320a may be referred to as front receptacle contacts 322. The receptacle contacts 300 in the second row 320b may be referred to as front central receptacle contacts 324. The receptacle contacts 300 in the third row 320c may be referred to as rear central receptacle contacts 326. The receptacle contacts 300 in the fourth row 320d may be referred to as rear receptacle contacts 328.

In an exemplary embodiment, the receptacle shields 350 are identical to each other and inverted 180° for coupling to opposite sides of the receptacle connector housing 200. Optionally, the receptacle shields 350 may be stamped and formed. Each receptacle shield 350 includes a shield plate 352 extending between a top and a bottom. The receptacle shield 350 includes housing tabs 354 configured to be coupled to the receptacle connector housing 200 and circuit board tabs 356 configured to be coupled to the receptacle circuit board 110. For example, the circuit board tabs 356 may be solder tabs or compliant pins, such as press-fit pins, configured to be press-fit into vias in the receptacle circuit board 110. The receptacle shield 350 includes a mating tab 358 configured to be mated with the header connector assembly 104 to electrically common the receptacle connector assembly 102 and the header connector assembly 104. The mating tab 358 may be stamped from the shield plate 352 and bent outward therefrom for interference with the header connector assembly 104 during mating. Other types of mating features may be provided in alternative embodiments.

The receptacle shields 350 are configured to be coupled to the receptacle connector housing 200, such as at the front wall 230 and the rear wall 240. The receptacle connector housing 200 includes openings 270 at the mating end 210 that receive the housing tabs 354. The openings 270 position the receptacle shield 350 relative to the receptacle connector housing 200. The receptacle connector housing 200 includes windows 272 formed between feet 274 at the base 214. The windows 272 receive the circuit board tabs 356. The feet 274 provide additional surface area at the base 214 for mounting the receptacle connector housing 200 to the receptacle circuit board 110. In an exemplary embodiment, the receptacle connector housing 200 includes pockets 276 at the feet 274 that receive bottom portions of the spring plate 352 to secure the receptacle shield 350 to the receptacle connector housing 200.

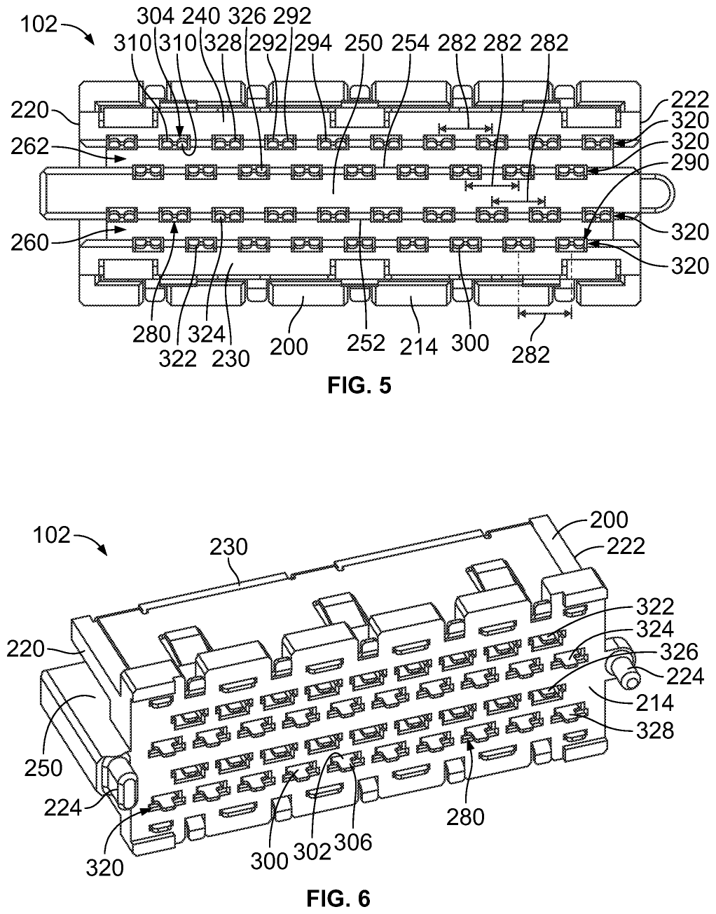

FIG. 5 is a top view of the receptacle connector assembly 102 in accordance with an exemplary embodiment. FIG. 6 is a bottom perspective view of the receptacle connector assembly 102 in accordance with an exemplary embodiment. The base 214 is provided at the bottom of the receptacle connector housing 200. The front wall 230, the rear wall 240, and the central wall 250 extend from the base 214 to form the receptacles 260, 262.

In an exemplary embodiment, the receptacle connector housing 200 includes contact channels 280 through the base 214. The contact channels 280 receive corresponding receptacle contacts 300. For example, the main body 302 of the receptacle contacts 300 may be held in the corresponding contact channels 280. The terminating ends 306 extend from the base 214 for termination to the receptacle circuit board 110 (shown in FIG. 1). The mating ends 304 extend from the base 214 into the receptacles 260, 262.

In an exemplary embodiment, the receptacles 260, 262 are open between the first and second ends 220, 222. For example, walls are not provided between the adjacent receptacle contacts 300. The receptacle contacts 300 are provided along both sides of the receptacles 260, 262. For example, the receptacle contacts 300 are staggered laterally across the receptacles 260, 262. In an exemplary embodiment, the receptacle contacts 300 in each of the rows 320 are spaced at the same receptacle contact pitch 282. However, the receptacle contacts 300 in different rows 320 may be arranged at different receptacle contact pitches. In an exemplary embodiment, the front receptacle contacts 322 extend along the front wall 230 and are exposed at the front receptacle 260. The front central receptacle contacts 324 extend along the front side 252 of the central wall 250 and are exposed at the front receptacle 260. The rear central receptacle contacts 326 extend along the rear side 254 of the central wall 250 and are exposed at the rear receptacle 262. The rear receptacle contacts 328 extend along the rear wall 240 and are exposed at the rear receptacle 262. The central wall 250 separates the front receptacle contacts 322 and the front central receptacle contacts 324 associated with the front receptacle 260 from the rear receptacle contacts 328 and the rear central receptacle contacts 326 associated with the rear receptacle 262.

In an exemplary embodiment, the front receptacle contacts 322 and the front central receptacle contacts 324 are laterally offset on opposite sides of the front receptacle 260 and longitudinally staggered relative to each other on opposite sides of the front receptacle 260. For example, the front receptacle contacts 322 and the front central receptacle contacts 324 are arranged in a zigzag pattern across the front receptacle 260. In an exemplary embodiment, the front receptacle contacts 322 and the front central receptacle contacts 324 are longitudinally offset relative to each other such that the front receptacle contacts 322 are centered between the front central receptacle contacts 324 on opposite sides of the front receptacle 260 and the front central receptacle contacts 324 are centered between the front receptacle contacts 322 on opposite sides of the front receptacle 260. In an exemplary embodiment, the rear receptacle contacts 328 and the rear central receptacle contacts 326 are longitudinally offset relative to each other such that the rear receptacle contacts 328 are centered between the rear central receptacle contacts 326 on opposite sides of the rear receptacle 262 and the rear central receptacle contacts 326 are centered between the rear receptacle contacts 328 on opposite sides of the rear receptacle 262.

The arrangement of the receptacle contacts 300 in the receptacle connector housing 200 provides a staggered mating interface for mating with the header connector assembly 104 and provides a staggered terminating interface for termination to the receptacle circuit board 110. The lateral and longitudinal staggering of the receptacle contacts 300 provides a high-density receptacle connector assembly 102 while minimizing the risk of short-circuiting between the receptacle contacts 300 during mating by increasing spacing between the nearest receptacle contacts 300. The lateral and longitudinal staggering of the receptacle contacts 300 allows for efficient trace routing at the receptacle circuit board 110. The mounting tabs 224 extend outward from the first and second ends 220, 222 such that the mounting tabs 224 are located outside of the pin field of the receptacle contacts 300. As such, the mounting tabs 224, and the corresponding openings in the receptacle circuit board 110, do not interfere with the routing of the traces through the receptacle circuit board 110.

As shown in FIG. 5, the receptacle connector housing 200 includes pockets 290 that receive the receptacle contacts 300 to position the mating ends 304 of the receptacle contacts 300. The pockets 290 are defined by edges 292 and a connecting wall 294 between the edges 292. The pockets 290 are recessed in the walls of the receptacle connector housing 200, such as the front wall 230, the rear wall 240, and both sides of the central wall 250. The mating ends 304 of the receptacle contacts 300 are located between the edges 292 to hold side to side positions of the mating end 304. Optionally, the spring beams 310 are deflectable (for example, movable) within the pockets 290. For example, the spring beams 310 may be deflected toward the corresponding connecting wall 294 (for example, deflected toward the corresponding front wall 230, the rear wall 240, or the central wall 250).

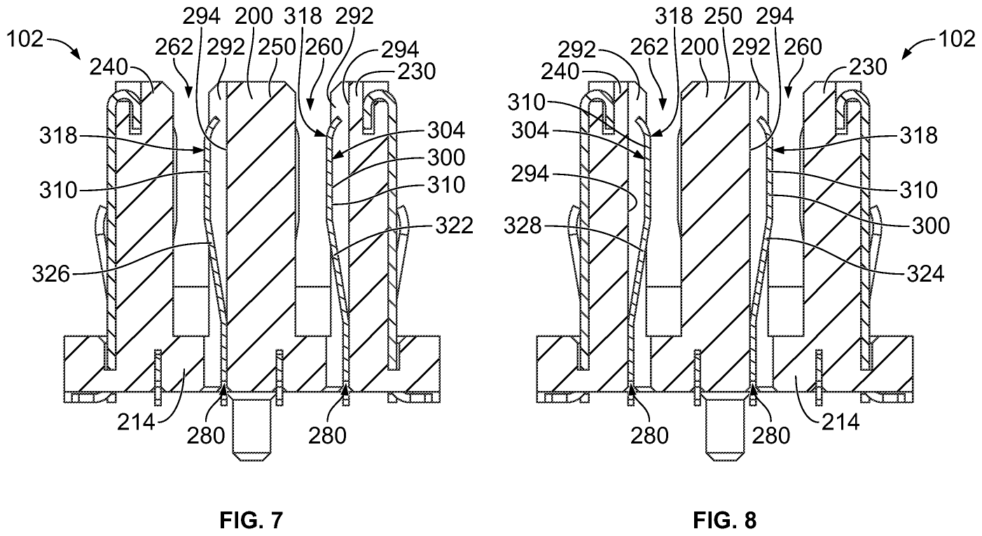

FIG. 7 is a cross-sectional view of the receptacle connector assembly 102 in accordance with an exemplary embodiment taken through one of the front receptacle contacts 322 and one of the rear central receptacle contacts 326. FIG. 8 is a cross-sectional view of the receptacle connector assembly 102 in accordance with an exemplary embodiment taken through one of the rear receptacle contacts 328 and one of the front central receptacle contacts 324. The receptacle contacts 300 pass through the contact channels 280 in the base 214 of the receptacle connector housing 200. The mating ends 304 are located in the receptacles 260, 262. In an exemplary embodiment, the spring beams 310 are curved inward into the receptacles 260, 262 to interface with the header connector assembly 104 and the header connector assembly 104 is received in the receptacles 260, 262. The spring beams 310 are spaced apart from the walls, such as the connecting walls 294 of the front wall 230, the rear wall 240 and the central wall 250 to allow the spring beams 310 to be deflected inward (for example, toward the connecting wall 294. The edges 294 protect portions of the spring beams 310, such as the distal ends of the spring beams 310. However, portions of the spring beams 310, such as the mating interfaces 318, stand proud of the edges 294 in the receptacles 260, 262 to interface with the header connector assembly 104.

FIG. 9 is a top perspective view of the header connector assembly 104 in accordance with an exemplary embodiment. The header connector housing 400 holds a plurality of the header contacts 500 in a plurality of rows. In an exemplary embodiment, the header connector assembly 104 includes one or more header shields 550 that provide electrical shielding for the header contacts 500. In the illustrated embodiment, the header shields 550 are provided at the front and rear ends of the header connector assembly 104 to shield the header contacts 500 from interference with components outside of the header connector assembly 104. The header shields 550 are configured to be electrically connected to and commoned with the receptacle shields 350 (shown in FIG. 3).

The header connector housing 400 includes a housing body 402. The housing body 402 is manufactured from a dielectric material, such as a plastic material. For example, the housing body 402 may be a molded part. In an exemplary embodiment, the housing body 402 is a single piece structure. However, in alternative embodiments, the housing body 402 may be a multi-piece structure. The housing body 402 is used to hold the header contacts 500 and the header shields 550. The dielectric material of the housing body 402 isolates the header contacts 500 from each other and from the header shields 550.

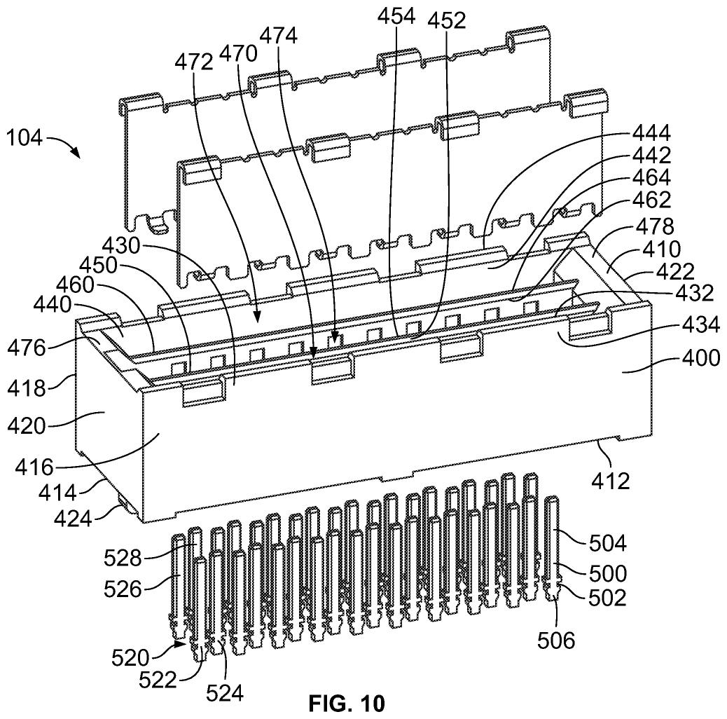

FIG. 10 is an exploded view of the header connector assembly 104 in accordance with an exemplary embodiment. FIG. 10 shows the header contacts 500 below the header connector housing 400. FIG. 10 shows the header shields 550 above the header connector housing 400. The header contacts 500 may be loaded into the header connector housing 400 from below and the header shields 550 may be coupled to the header connector housing 400 from above. The header connector assembly 104 may be assembled in other ways in alternative embodiments. The header connector assembly 104 may have other orientations in alternative embodiments.

The header connector housing 400 extends between a mating end 410 and a mounting end 412. The mating end 410 is configured to be mated with the receptacle connector assembly 102 (shown in FIG. 3). In the illustrated embodiment, the mating end 410 is provided at the top and the mounting end 412 is provided at the bottom. Other orientations are possible in alternative embodiments. In an exemplary embodiment, the header connector housing 400 includes a base 414 at the mounting end 412. The base 414 is configured to be mounted to the header circuit board 112 (shown in FIG. 1). In an exemplary embodiment, the base 414 extends the entire width and the entire length of the header connector housing 400.

The header connector housing 400 includes a front 416 and a rear 418. Optionally, the front 416 and/or the rear 418 may be generally planar and parallel to each other. Optionally, the header connector housing 400 may include pockets, slots, openings, protrusions, tabs, or other features at the front 416 and/or at the rear 418, such as to accommodate the header shields 550.

The header connector housing 400 includes a first end 420 and a second end 422 opposite the first end 420. In an exemplary embodiment, the header connector housing 400 includes mounting tabs 424 at the first end 420 and/or the second end 422 for mounting the header connector housing 400 to the header circuit board 112. For example, the mounting tabs 424 may extend from the mounting end 412. The mounting tabs 424 may include posts or other protrusions configured to extend into openings in the header circuit board 112. In alternative embodiments, the mounting tabs 424 may include openings, such as to receive fasteners or other securing features for securing the header connector housing 400 to the header circuit board 112.

The header connector housing 400 includes a front outer wall 430 extending longitudinally between the first end 420 and the second end 422 of the header connector housing 400. The front outer wall 430 includes an inner side 432 and an outer side 434. The outer side 434 faces an exterior of the header connector housing 400. In an exemplary embodiment, the header shield 550 is configured to be coupled to the inner side 432 of the front outer wall 430.

The header connector housing 400 includes a rear outer wall 440 extending longitudinally between the first end 420 and the second end 422 of the header connector housing 400. The rear outer wall 440 includes an inner side 442 and an outer side 444. The outer side 444 faces an exterior of the header connector housing 400. In an exemplary embodiment, the header shield 550 is configured to be coupled to the inner side 442 of the rear outer wall 440.

In an exemplary embodiment, the header connector housing 400 includes a front inner wall 450 extending longitudinally between the first end 420 and the second end 422 of the header connector housing 400. The front inner wall 450 includes a front side 452 and a rear side 454. The front inner wall 450 is positioned laterally between the front outer wall 430 and the rear outer wall 440. The front inner wall 450 may be positioned closer to the front outer wall 430 than the rear outer wall 440. The front inner wall 450 extends parallel to the front outer wall 430. A plurality of the header contacts 500 are arranged along both sides 452, 454 of the front inner wall 450 in corresponding rows.

In an exemplary embodiment, the header connector housing 400 includes a rear inner wall 460 extending longitudinally between the first end 420 and the second end 422 of the header connector housing 400. The rear inner wall 460 includes a front side 462 and a rear side 464. The rear inner wall 460 is positioned laterally between the front outer wall 430 and the rear outer wall 440. The rear inner wall 460 may be positioned closer to the rear outer wall 440 than the front outer wall 430. The rear inner wall 460 extends parallel to the rear outer wall 440. A plurality of the header contacts 500 are arranged along both sides 462, 464 of the rear inner wall 460 in corresponding rows.

A front slot 470 is located between the front outer wall 430 and front inner wall 450. The front side 452 of the front inner wall 450 faces the front slot 470. The inner side 432 of the front outer wall 430 faces the front slot 470. A rear slot 472 is located between the rear outer wall 440 and the rear inner wall 460. The rear side 454 of the rear inner wall 460 faces the rear slot 472. The inner surface 442 of the rear outer wall 440 faces the rear slot 472. A central slot 474 is located between the front inner wall 450 and the rear inner wall 460. The rear side 454 of the front inner wall 450 faces the central slot 474. The front side 462 of the rear inner wall 460 faces the central slot 474. In an exemplary embodiment, the header connector housing 400 includes a first end wall 476 at the first end 420 and a second end wall 478 at the second end 422. The end walls 476, 478 close the slots 470, 472, 474. The end walls 476, 478 support the front and rear inner walls 450, 460.

In an exemplary embodiment, each of the header contacts 500 are identical. However, in alternative embodiments, the header contacts 500 may be sized and shaped differently and/or include different features from each other. In an exemplary embodiment, the header contacts 500 are stamped and formed contacts. Each header contacts 500 includes a main body 502, a mating end 504 extending from the main body 502 and a terminating end 506 extending from the main body 502. In the illustrated embodiment, the mating end 504 is provided at the top of the header contact 500 and the terminating end 506 is provided at the bottom of the header contact 500. Other orientations are possible in alternative embodiments. In the illustrated embodiment, the header contacts 500 extend generally vertically; however, the header contacts 500 may have other shapes or orientations in alternative embodiments.

In the illustrated embodiment, the terminating end 506 is illustrated as a solder tab. However, other types of terminating ends may be provided in alternative embodiments, such as compliant pins (for example, eye of the needle pins), spring beams, solder tails, or other types of terminating ends.

In an exemplary embodiment, the mating end 504 includes a blade 510. The blade 510 is coplanar with the main body 502. The blade 510 is cantilevered from the main body 502. Other types of mating ends may be provided in alternative embodiments, such as a deflectable spring beam, a pin, a socket, and the like.

In an exemplary embodiment, the header contacts 500 are arranged in a plurality of rows 520. For example, a first row 520a of the header contacts 500 may be provided at the front side 252 of the front inner wall 450, a second row 520b of the header contacts 500 may be provided at the rear side 254 of the front inner wall 450, a third row 520c of the header contacts 500 may be provided at the front side 262 of the rear inner wall 460, and a fourth row 520d of the header contacts 500 may be provided at the rear side 264 of the rear inner wall 460. The header contacts 500 in the first row 520a may be referred to as front header contacts 522. The header contacts 500 in the second row 520b may be referred to as front central header contacts 524. The header contacts 500 in the third row 520c may be referred to as rear central header contacts 526. The header contacts 500 in the fourth row 520d may be referred to as rear header contacts 528.

In an exemplary embodiment, the header shields 550 are identical to each other and inverted 180° for coupling to opposite sides of the header connector housing 400. Optionally, the header shields 550 may be stamped and formed. Each header shield 550 includes a shield plate 552 extending between a top and a bottom. The header shield 550 includes housing tabs 554 configured to be coupled to the header connector housing 400 and circuit board tabs 556 configured to be coupled to the header circuit board 112. For example, the circuit board tabs 556 may be solder tabs or compliant pins, such as press-fit pins, configured to be press-fit into vias in the header circuit board 112. The header shield 550 includes a mating tab 558 configured to be mated with the receptacle connector assembly 102 (for example, the mating tabs 358) to electrically common the header connector assembly 104 and the receptacle connector assembly 102. The mating tab 558 may be stamped from the shield plate 552 and bent outward therefrom for interference with the receptacle connector assembly 102 during mating. Other types of mating features may be provided in alternative embodiments.

The header shields 550 are configured to be coupled to the header connector housing 400, such as at the front outer wall 430 and the rear outer wall 440. The header connector housing 400 includes openings 470 at the mating end 410 that receive the housing tabs 554. The openings 470 position the header shield 550 relative to the header connector housing 400. The header connector housing 400 includes windows 472 formed between feet 474 at the base 414. The windows 472 receive the circuit board tabs 556. The feet 474 provide additional surface area at the base 414 for mounting the header connector housing 400 to the header circuit board 112. In an exemplary embodiment, the header connector housing 400 includes pockets 476 at the feet 474 that receive bottom portions of the spring plate 552 to secure the header shield 550 to the header connector housing 400.

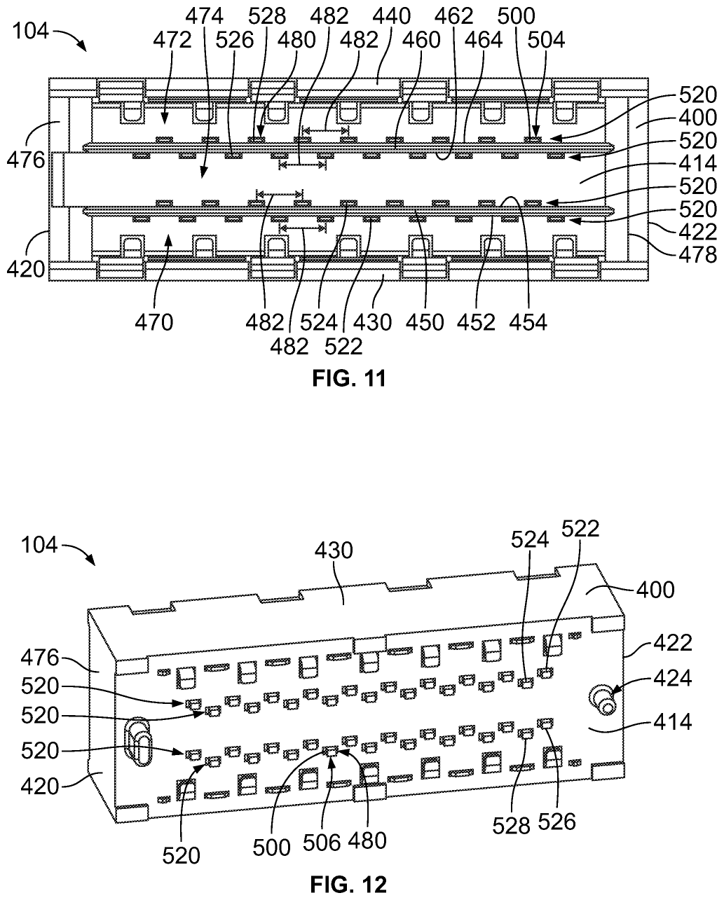

FIG. 11 is a top view of the header connector assembly 104 in accordance with an exemplary embodiment. FIG. 12 is a bottom perspective view of the header connector assembly 104 in accordance with an exemplary embodiment. The base 414 is provided at the bottom of the header connector housing 400. The front outer wall 430, the rear outer wall 440, the front inner wall 450, and the rear inner wall 460 extend from the base 414 to form the slots 470, 472.

In an exemplary embodiment, the header connector housing 400 includes contact channels 480 through the base 414. The contact channels 480 receive corresponding header contacts 500. For example, the main body 502 of the header contacts 500 may be held in the corresponding contact channels 480. The terminating ends 506 extend from the base 414 for termination to the header circuit board 112 (shown in FIG. 1). The mating ends 504 extend from the base 414 into the slots 470, 472.

In an exemplary embodiment, the slots 470, 472, 474 are closed at the first and second ends 420, 422 by the end walls 476, 478. The header contacts 500 are provided along both sides of the inner walls 450, 460 to face each of the slots 470, 472, 474. The header contacts 500 are staggered laterally on opposites sides 452, 454 of the front inner wall 450 and staggered laterally on opposites sides 462, 464 of the rear inner wall 460. The header contacts 500 are staggered laterally across the central slot 474. In an exemplary embodiment, the header contacts 500 in each of the rows 520 are spaced at the same header contact pitch 482. However, the header contacts 500 in different rows 520 may be arranged at different header contact pitches.

In an exemplary embodiment, the front header contacts 522 extend along the front side 452 of the front inner wall 450 and are exposed at the front slot 470. The front central header contacts 524 extend along the rear side 454 of the front inner wall 450 and are exposed at the central slot 474. The rear central header contacts 526 extend along the front side 462 of the rear inner wall 460 and are exposed at the central slot 474. The rear header contacts 528 extend along the rear side 464 of the rear inner wall 460 and are exposed at the rear slot 472. The front inner wall 450 separates the front header contacts 522 and the front central header contacts 524. The rear inner wall 460 separates the rear header contacts 528 and the rear central header contacts 526.

In an exemplary embodiment, the front header contacts 522 and the front central header contacts 524 are laterally offset on opposite sides of the front inner wall 450 and longitudinally staggered relative to each other on opposite sides of the front inner wall 450. For example, the front header contacts 522 and the front central header contacts 524 are arranged in a zigzag pattern on opposite sides of the front inner wall 450. In an exemplary embodiment, the front header contacts 522 and the front central header contacts 524 are longitudinally offset relative to each other such that the front header contacts 522 are centered between the front central header contacts 524 on opposite sides of the front inner wall 450 and the front central header contacts 524 are centered between the front header contacts 522 on opposite sides of the front inner wall 450. In an exemplary embodiment, the rear header contacts 528 and the rear central header contacts 526 are longitudinally offset relative to each other such that the rear header contacts 528 are centered between the rear central header contacts 526 on opposite sides of the rear inner wall 460 and the rear central header contacts 526 are centered between the rear header contacts 528 on opposite sides of the rear inner wall 460.

The arrangement of the header contacts 500 in the header connector housing 400 provides a staggered mating interface for mating with the receptacle connector assembly 102 and provides a staggered terminating interface for termination to the header circuit board 112. The lateral and longitudinal staggering of the header contacts 500 provides a high-density header connector assembly 104 while minimizing the risk of short-circuiting between the header contacts 500 during mating by increasing spacing between the nearest header contacts 500. The lateral and longitudinal staggering of the header contacts 500 allows for efficient trace routing at the header circuit board 112. The mounting tabs 424 extend outward from the first and second ends 420, 422 such that the mounting tabs 424 are located outside of the pin field of the header contacts 500. As such, the mounting tabs 424, and the corresponding openings in the header circuit board 112, do not interfere with the routing of the traces through the header circuit board 112.

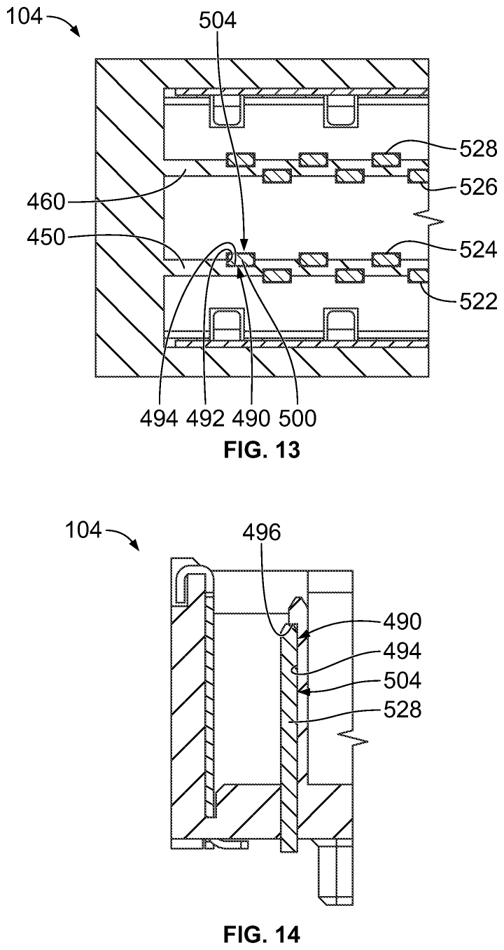

FIG. 13 is a horizontal cross sectional view of a portion of the header connector assembly 104 in accordance with an exemplary embodiment. FIG. 14 is a vertical cross sectional view of a portion of the header connector assembly 104 in accordance with an exemplary embodiment. FIG. 14 shows the rear header contact 528. FIG. 13 shows the front header contacts 522 and the front central header contacts 524 extending along the front inner wall 450 and the rear central header contacts 526 and the rear header contacts 528 extending along the rear inner wall 460.

The header connector housing 400 includes pockets 490 that receive the header contacts 500 to position the mating ends 504 of the header contacts 500. The pockets 490 are defined by edges 492 (FIG. 13) and a connecting wall 494 between the edges 492. The pockets 490 are recessed in the walls of the header connector housing 400 holding the header contacts 500, such as the front inner wall 450 and the rear inner wall 460. A cap wall 496 (FIG. 14) is provided above the header contacts 500 to prevent stubbing during mating.

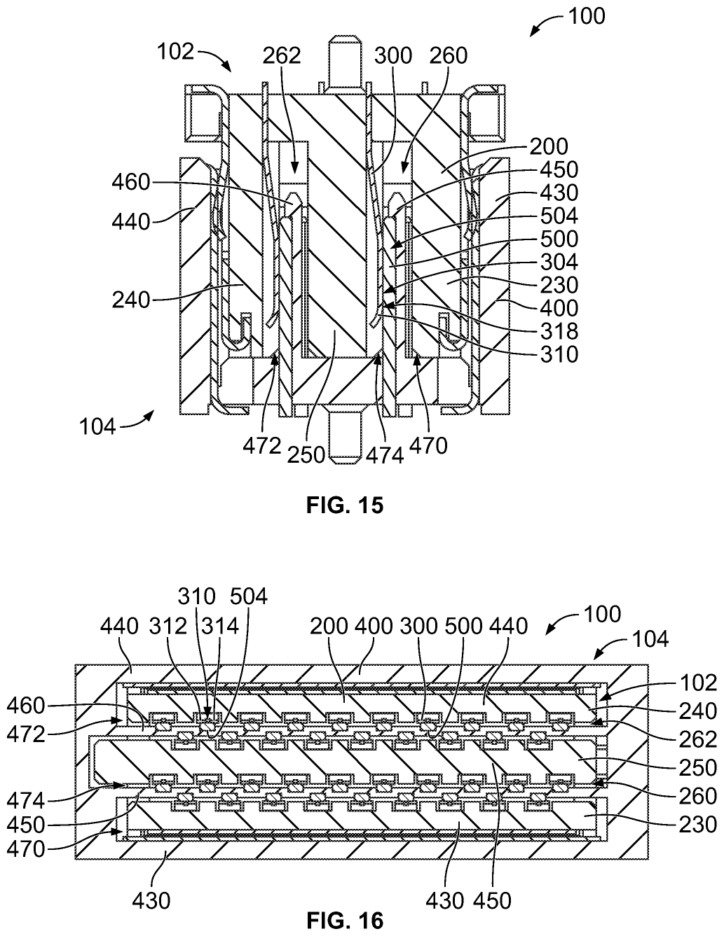

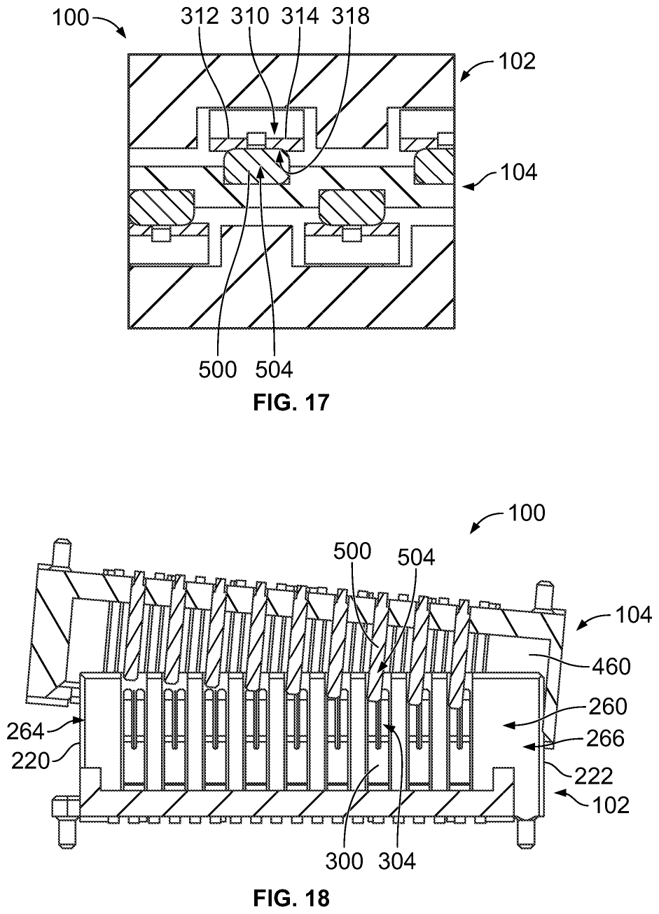

FIG. 15 is a vertical cross-sectional view of the electrical connector system 100 showing the receptacle connector assembly 102 mated with the header connector assembly 104. FIG. 16 is a horizontal cross-sectional view of the electrical connector system 100 showing the receptacle connector assembly 102 mated with the header connector assembly 104. FIG. 17 is an enlarged view of a portion fo the electrical connector system 100 shown in FIG. 16.

When mated, the receptacle contacts 300 are electrically connected with the header contacts 500. During mating, the receptacle connector housing 200 is plugged into the header connector housing 400. For example, the front wall 230 is received in the front slot 470, the rear wall 240 is received in the rear slot 472, and the central wall 250 is received in the central slot 474. When mated, the front outer wall 430 of the header connector housing 400 is located outward of (forward of) the front wall 230 of the receptacle connector housing 200 and the rear outer wall 440 of the header connector housing 400 is located outward of (rearward of) the rear wall 240. When mated, the front inner wall 450 of the header connector housing 400 is received in the front receptacle 260 and the rear inner wall 460 of the header connector housing 400 is received in the rear receptacle 262. The mating ends 304 of the receptacle contacts 300 are mated with the mating ends 504 of the header contacts 500. In an exemplary embodiment, both spring arms 312, 314 of the spring beam 310 of the receptacle contacts 300 are coupled to the mating end 504 of the corresponding header contact 500. As such, each receptacle contacts 300 has multiple points of contact with the corresponding header contact 500 defined by the mating interfaces 318 of the bifurcated spring beam 310. When mated, the receptacle shields 350 are electrically connected to the header shields 550.

FIG. 18 is a cross-sectional view of the electrical connector system 100 showing the header connector assembly 104 partially mated with the receptacle connector assembly 102. FIG. 18 illustrates the header connector assembly 104 be mated with the receptacle connector assembly 102 at a skewed angle. Having the receptacles 260, 262 of the receptacle connector housing 200 (between the first and second ends 220, 222) allows for skewed mating with the header connector assembly 104. For example, the inner walls 450, 460 pass through the receptacles 260, 262 and through the openings 264, 266 at the first and second ends 220, 222 allowing one end (for example, the first end 420) of the header connector housing 400 to be lower than the opposite end during mating. The open contact fields of the receptacle contacts 300 and the header contacts 500 accommodate the skewed mating. For example, the mating ends 504 of the header contacts 500 may pass across the mating ends 304 of the receptacle contacts 300 to the wall portions between the receptacle contacts 300. The additional spacing provided between the contacts (for example, due to the lateral and longitudinal staggering of the contacts) reduces the risk of short-circuiting the header contacts 500 with the incorrect, adjacent receptacle contacts 300.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector system comprising:
a receptacle connector assembly including a receptacle connector housing holding receptacle contacts in a plurality of rows, the receptacle connector housing having a mounting end and a mating end opposite the mounting end, the mounting end configured to be mounted to a circuit board, the receptacle connector housing having a front wall extending longitudinally between a first end and a second end of the receptacle connector housing, the receptacle connector housing having a rear wall extending longitudinally between the first end and the second end, the receptacle connector housing having a central wall positioned laterally between the front wall and the rear wall and extending parallel to the front wall and the rear wall, the receptacle connector housing having a front receptacle between the front wall and the central wall, the receptacle connector housing having a rear receptacle between the rear wall and the central wall, the front and rear receptacles being open at the first and second ends of the receptacle connector housing, the receptacle contacts including front receptacle contacts, rear receptacle contacts, front central receptacle contacts and rear central receptacle contacts, the front receptacle contacts extending along the front wall and exposed at the front receptacle, the rear receptacle contacts extending along the rear wall and exposed at the rear receptacle, the front central receptacle contacts extending along a front side of the central wall and exposed at the front receptacle, the rear central receptacle contacts extending along a rear side of the central wall and exposed at the rear receptacle, wherein the front receptacle contacts and the front central receptacle contacts are laterally offset on opposite sides of the front receptacle and longitudinally staggered relative to each other on opposite sides of the front receptacle, and wherein the rear receptacle contacts and the rear central receptacle contacts are laterally offset on opposite sides of the rear receptacle and longitudinally staggered relative to each other on opposite sides of the rear receptacle;
a header connector configured to be mated with the receptacle connector, the header connector including a header connector housing holding header contacts in a plurality of rows, the header connector housing having a mounting end and a mating end opposite the mounting end, the mounting end configured to be mounted to a circuit board, the mating end of the header connector housing being mated to the mating end of the receptacle connector housing, the header connector housing having a front outer wall extending longitudinally between a first end and a second end of the header connector housing, the header connector housing having a rear outer wall extending longitudinally between the first end and the second end, the header connector housing having a front inner wall positioned laterally between the front wall and the rear wall closer to the front outer wall than the rear outer wall, the header connector housing having a rear inner wall positioned laterally between the front wall and the rear wall closer to the rear outer wall than the front outer wall, the header connector housing having a front slot between the front outer wall and the front inner wall, the header connector housing having a rear slot between the rear outer wall and the rear inner wall, the header connector housing having a central slot between the front inner wall and the rear inner wall, the front slot receiving the front wall of the receptacle connector housing, the rear slot receiving the rear wall of the receptacle connector housing, the central slot receiving the central wall of the receptacle connector housing, the header contacts including front header contacts, rear header contacts, front central header contacts and rear central header contacts, the front header contacts extending along a front side of the front inner wall and exposed at the front slot, the rear header contacts extending along a rear side of the rear inner wall and exposed at the rear slot, the front central header contacts extending along a rear side of the front inner wall and exposed at the central header, the rear central header contacts extending along a front side of the rear inner wall and exposed at the central slot, wherein the front header contacts and the front central header contacts are longitudinally staggered relative to each other on opposite sides of the front inner wall, and wherein the rear header contacts and the rear central header contacts are longitudinally staggered relative to each other on opposite sides of the rear inner wall;
wherein the front wall of the receptacle connector housing is received in the front slot of the header connector housing, the rear wall of the receptacle connector housing is received in the rear slot of the header connector housing, and the central wall of the receptacle connector housing is received in the central slot of the header connector housing; and
wherein the front receptacle contacts are electrically connected with corresponding front header contacts, the rear receptacle contacts are electrically connected with corresponding rear header contacts, the front central receptacle contacts are electrically connected with corresponding front central header contacts, the rear central receptacle contacts are electrically connected with corresponding rear central header contacts.

2. The electrical connector system of claim 1, wherein the receptacle connector housing includes a base at the mounting end, the front wall, the rear wall, and the central wall extending from the base to the mating end, the base including contact channels receiving the receptacle contacts, the receptacle contacts including terminating ends extending from the base for termination to the circuit board, and wherein the header connector housing includes a base at the mounting end, the front outer wall, the front inner wall, the rear inner wall, and the rear outer wall extending from the base to the mating end, the base including contact channels receiving the header contacts, the header contacts including terminating ends extending from the base for termination to the circuit board.

3. The electrical connector system of claim 1, wherein the receptacle connector assembly includes a front receptacle shield coupled to the front wall and a rear receptacle shield coupled to the rear wall to provide electrical shielding therebetween for the receptacle contacts, the header connector assembly including a front header shield coupled to the front outer wall and a rear header shield coupled to the rear outer wall to provide electrical shielding therebetween for the header contacts, the front receptacle shield engaging the front header shield, the rear receptacle shield engaging the rear header shield.

4. The electrical connector system of claim 1, wherein each receptacle contact includes a deflectable spring beam engaging the corresponding header contact, the spring beam being deflectable when mated to the header contact.

5. The electrical connector system of claim 4, wherein the spring beams of the front receptacle contacts are deflected toward the front wall, the spring beams of the front central receptacle contacts are deflected toward the central wall, the spring beams of the rear central receptacle contacts are deflected toward the central wall, and the spring beams of the rear receptacle contacts are deflected toward the rear wall.

6. The electrical connector system of claim 1, wherein the receptacle contacts include deflectable spring beams, each deflectable spring beam being split at a mating end thereof to include a first spring arm having a first mating interface and a second spring arm having a second mating interface, each spring beam having multiple points of contact with the corresponding header contact.

7. The electrical connector system of claim 1, wherein the receptacle connector housing includes mounting tabs at the first end and the second end, the mounting tabs configured to engage the circuit board to position the receptacle connector housing and the receptacle contacts relative to the circuit board, and wherein the header connector housing includes mounting tabs at the first end and the second end, the mounting tabs configured to engage the circuit board to position the header connector housing in the header contacts relative to the circuit board.

8. The electrical connector system of claim 1, wherein the front wall includes front wall pockets receiving mating ends of the front receptacle contacts, the rear wall includes rear wall pockets receiving mating ends of the rear receptacle contacts, the central wall including central wall pockets on the front side and the rear side receiving mating ends of the front central receptacle contacts and the rear central receptacle contacts, respectively.

9. The electrical connector system of claim 1, wherein the header connector housing includes a first end wall at the first end and a second end wall at the second end, the first and second end walls closing the front slot, the rear slot, and the central slot.

10. The electrical connector system of claim 1, wherein the front header contacts are centered between the front central header contacts on opposite sides of the front inner wall, the front central header contacts are centered between the front header contacts on opposite sides of the front inner wall, the rear header contacts are centered between the rear central header contacts on opposite sides of the rear inner wall, and the rear central header contacts are centered between the rear header contacts on opposite sides of the rear inner wall.

11. The electrical connector system of claim 1, wherein the front receptacle contacts are spaced at a receptacle contact pitch, the rear receptacle contacts are spaced at the receptacle contact pitch, the front central receptacle contacts are spaced at the receptacle contact pitch, and the rear central receptacle contacts are spaced at the receptacle contact pitch.

12. The electrical connector system of claim 1, wherein the front inner wall extends from the front receptacle at the first end of the receptacle connector housing and extends from the front receptacle at the second end of the receptacle connector housing, and wherein the rear inner wall extends from the rear receptacle at the first end of the receptacle connector housing and extends from the rear receptacle at the second end of the receptacle connector housing.

13. A receptacle connector assembly comprising:
a receptacle connector housing having a mounting end and a mating end opposite the mounting end, the mounting end configured to be mounted to a circuit board, the mating end of the receptacle connector housing configured to be mated to a header connector housing the receptacle connector housing having a front wall extending longitudinally between a first end and a second end of the receptacle connector housing, the receptacle connector housing having a rear wall extending longitudinally between the first end and the second end, the receptacle connector housing having a central wall positioned laterally between the front wall and the rear wall and extending parallel to the front wall and the rear wall;
a front receptacle between the front wall and the central wall, the front receptacle being open at the first and second ends of the receptacle connector housing;
a rear receptacle between the rear wall and the central wall, the rear receptacle being open at the first and second ends of the receptacle connector housing;
front receptacle contacts extending along the front wall and exposed at the front receptacle;
rear receptacle contacts extending along the rear wall and exposed at the rear receptacle;
front central receptacle contacts extending along a front side of the central wall and exposed at the front receptacle; and
rear central receptacle contacts extending along a rear side of the central wall and exposed at the rear receptacle;
wherein the front receptacle contacts and the front central receptacle contacts are laterally offset on opposite sides of the front receptacle and longitudinally staggered relative to each other on opposite sides of the front receptacle;
wherein the rear receptacle contacts and the rear central receptacle contacts are laterally offset on opposite sides of the rear receptacle and longitudinally staggered relative to each other on opposite sides of the rear receptacle.

14. The receptacle connector assembly of claim 13, wherein the receptacle connector housing includes a base at the mounting end, the front wall, the rear wall, and the central wall extending from the base to the mating end, the base including contact channels receiving the receptacle contacts, the receptacle contacts including terminating ends extending from the base for termination to the circuit board.

15. The receptacle connector assembly of claim 13, wherein the receptacle connector assembly includes a front receptacle shield coupled to the front wall and a rear receptacle shield coupled to the rear wall to provide electrical shielding therebetween for the receptacle contacts.

16. The receptacle connector assembly of claim 13, wherein each receptacle contact includes a deflectable spring beam engaging the corresponding header contact, the spring beam being deflectable when mated to the header contact, the spring beams of the front receptacle contacts being deflected toward the front wall, the spring beams of the front central receptacle contacts being deflected toward the central wall, the spring beams of the rear central receptacle contacts being deflected toward the central wall, and the spring beams of the rear receptacle contacts being deflected toward the rear wall.

17. The receptacle connector assembly of claim 13, wherein the receptacle contacts include deflectable spring beams, each deflectable spring beam being split at a mating end thereof to include a first spring arm having a first mating interface and a second spring arm having a second mating interface, each spring beam having multiple points of contact with the corresponding header contact.

18. The receptacle connector assembly of claim 13, wherein the receptacle connector housing includes mounting tabs at the first end and the second end, the mounting tabs configured to engage the circuit board to position the receptacle connector housing and the receptacle contacts relative to the circuit board.

19. The receptacle connector assembly of claim 13, wherein the front wall includes front wall pockets receiving mating ends of the front receptacle contacts, the rear wall includes rear wall pockets receiving mating ends of the rear receptacle contacts, the central wall including central wall pockets on the front side and the rear side receiving mating ends of the front central receptacle contacts and the rear central receptacle contacts, respectively.

20. The receptacle connector assembly of claim 13, wherein the front receptacle contacts are centered between the front central receptacle contacts on opposite sides of the front slot, the front central receptacle contacts are centered between the front receptacle contacts on opposite sides of the front slot, the rear receptacle contacts are centered between the rear central receptacle contacts on opposite sides of the rear slot, and the rear central receptacle contacts are centered between the rear receptacle contacts on opposite sides of the rear slot.

21. The receptacle connector assembly of claim 13, wherein the front receptacle contacts are spaced at a receptacle contact pitch, the rear receptacle contacts are spaced at the receptacle contact pitch, the front central receptacle contacts are spaced at the receptacle contact pitch, and the rear central receptacle contacts are spaced at the receptacle contact pitch.

22. A header connector assembly comprising:
a header connector housing having a mounting end and a mating end opposite the mounting end, the mounting end configured to be mounted to a circuit board, the mating end of the header connector housing configured to be mated to a receptacle connector housing, the header connector housing having a front outer wall extending longitudinally between a first end and a second end of the header connector housing, the header connector housing having a rear outer wall extending longitudinally between the first end and the second end, the header connector housing having a front inner wall positioned laterally between the front wall and the rear wall closer to the front outer wall than the rear outer wall, the header connector housing having a rear inner wall positioned laterally between the front wall and the rear wall closer to the rear outer wall than the front outer wall;
a front slot between the front outer wall and the front inner wall, the front slot configured to receive a front wall of the receptacle connector housing;
a rear slot between the rear outer wall and the rear inner wall, the rear slot configured to receive a rear wall of the receptacle connector housing;
a central slot between the front inner wall and the rear inner wall, the central slot configured to receive a central wall of the receptacle connector housing;
front header contacts extending along a front side of the front inner wall and exposed at the front slot;
rear header contacts extending along a rear side of the rear inner wall and exposed at the rear slot;
front central header contacts extending along a rear side of the front inner wall and exposed at the central header; and
rear central header contacts extending along a front side of the rear inner wall and exposed at the central slot;
wherein the front header contacts and the front central header contacts are longitudinally staggered relative to each other on opposite sides of the front inner wall; and
wherein the rear header contacts and the rear central header contacts are longitudinally staggered relative to each other on opposite sides of the rear inner wall.
